(19) United States
(12) Patent Application Publication
(10) Pub. No.: US 2026/0105718 A1
(43) Pub. Date: Apr. 16, 2026

(54) METHOD AND DEVICE WITH IMAGE FEATURE GENERATION

(71) Applicant: Samsung Electronics Co., Ltd., Suwon-si (KR)

(72) Inventors: Ho-Ik CHOI, Suwon-si (KR); Ui Kun KWON, Suwon-si (KR); Junyoung BYUN, Suwon-si (KR); Sung Hyun CHUNG, Suwon-si (KR)

(73) Assignee: Samsung Electronics Co., Ltd., Suwon-si (KR)

(21) Appl. No.: 19/091,400

(22) Filed: Mar. 26, 2025

(30) Foreign Application Priority Data
Oct. 14, 2024 (KR) 10-2024-0139418

(51) Int. Cl. G06V 10/44; G06T 7/20; H04N 19/176

(52) U.S. Cl. CPC G06V 10/44; G06T 7/20; H04N 19/176

(57) ABSTRACT

A method and device with image feature generation are provided. The method includes extracting a reference feature of a reference frame image, among a plurality of frame images, using a feature extraction model, generating partial compression information corresponding to a portion of a target frame image, where the portion of the target frame has a determined difference with a corresponding portion of the reference frame image that is greater than or equal to a predetermined threshold, generating a compression feature from the generated partial compression information using a feature derivation model, and generating, based on the reference feature and the compression feature, a target feature of the target frame image.

### CROSS-REFERENCE TO RELATED APPLICATIONS

This application claims the benefit under 35 USC § 119(a) of Korean Patent Application No. 10-2024-0139418, filed on Oct. 14, 2024, in the Korean Intellectual Property Office, the entire disclosure of which is incorporated by reference herein for all purposes.

### BACKGROUND

### 1. Field

The following description relates to a method and device with image feature generation.

### 2. Description of Related Art

Video compression technology may involve reducing the data size of an image or video. For example, such data size reduction may include a minimizing of information loss by utilizing characteristics of the image or video that has high similarity between adjacent frame images.

Machine learning models, such as convolution neural networks (CNNs), have been used in conjunction with image or video compression.

The above description is information the inventor acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes extracting a reference feature of a reference frame image, among a plurality of frame images, using a feature extraction model, generating partial compression information corresponding to a portion of a target frame image, where the portion of the target frame has a determined difference with a corresponding portion of the reference frame image that is greater than or equal to a predetermined threshold, generating a compression feature from the generated partial compression information using a feature derivation model, and generating, based on the reference feature and the compression feature, a target feature of the target frame image.

The generating of the partial compression information may include generating respective compression information, including the partial compression information, representing differences between the target frame image and the reference frame image, including partitioning the target frame image into a plurality of blocks, and determining, for each of the plurality of blocks, respective block compression information indicating a corresponding difference between a region corresponding to a corresponding block among the plurality of blocks and a corresponding block of the target frame image, and the partial compression information may be selected from among the respective compression information based on the determined difference.

A size of a first block among the plurality of blocks may be different from a size of a second block among the plurality of blocks.

The generating of the partial compression information may include generating respective compression information, including the partial compression information, representing differences between the target frame image and the reference frame image, and the method may further include partitioning the target frame image into a plurality of blocks, and selecting the portion of the target frame image by selecting, based on at least one of a motion vector of each of the plurality of blocks, a residual for each of the plurality of blocks with respect to the reference frame image, or a direct current (DC) component of the plurality of blocks, the portion of the target frame as a target block, among the plurality of blocks, that has the determined difference that may be greater than or equal to the predetermined threshold.

The generating of the compression feature may include generating the compression feature based on a result of applying the feature derivation model to the partial compression information and spatial information of the portion of the target frame, wherein the spatial information includes at least one of position information of the portion of the target frame or size information of the portion of the target frame.

The feature derivation model may be trained with a ground truth obtained by subtracting a feature of a first training frame image and a feature of a second training frame image from training partial compression information between the first training frame image and the second training frame image.

The method may further include selecting, as the reference frame image, one of a first frame image or a second frame image, respectively among the plurality of frame images, based on a determined difference between the first frame image and the second frame image.

The method may further include selecting the reference frame image as a frame image, among the plurality of frame images, in which an object is detected, and determining, based on the selected reference frame image, a frame image among the plurality of frame images that is subsequent to the reference frame image to be the target frame image.

The method may further include performing a detecting for an object in each of the plurality of frame images, and selecting, as the reference frame image, a frame image from among the plurality of frame images in which an object that was not detected in a previous frame image is detected as a result of the performed detecting or in which an object that was detected in the previous frame image is not detected as the result of the performed detecting.

The method may further include selecting another target frame image subsequent to the target frame image from among the plurality of frame images, and determining whether to reselect the reference frame image based on a portion of the other selected other target frame image having another determined difference with another corresponding portion of the reference frame image that is greater than or equal to the predetermined threshold.

The method may further include performing a detecting for an object in each of other frame images, subsequent to the target frame image, from among the plurality of frame images, selecting, based on the object being detected in one frame image of the other frame images as a result of the performed detecting, the one frame image to be another reference frame image or another target frame image, and generating features for the other frame images, except for any of the other frame images for which the performed detecting resulted in the object not being detected, using the feature extraction model or the feature derivation model.

The method may further include tracking, based on the reference feature and the target feature, an object appearing in the reference frame image and the target frame image, or generating, based on the reference feature and the target feature, caption text describing a scene appearing in the reference frame image and the target frame image.

In one general aspect, provided is a non-transitory computer-readable storage medium storing instructions that, when executed by a processor, cause the processor to perform any one, any combination, or all operations or methods described herein.

In one general aspect, electronic device includes one or more processors respectively comprising processing circuitry, and a memory storing code, which upon execution by the one or more processors, configures the one or more processors to extract a reference feature of a reference frame image, among a plurality of frame images, using a feature extraction model, generate partial compression information corresponding to a portion of a target frame image, where the portion of the target frame has a determined difference with a corresponding portion of the reference frame image that is greater than or equal to a predetermined threshold, generate a compression feature from the generated partial compression information using a feature derivation model, and generate, based on the reference feature and the compression feature, a target feature of the target frame image.

The generation of the partial compression information may include a generation of respective compression information, including the partial compression information, representing differences between the target frame image and the reference frame image, and the execution of the code by the one or more processors may configure the one or more processors to partition the target frame image into a plurality of blocks, and select the portion of the target frame image by selecting, based on at least one of a motion vector of each of the plurality of blocks, a residual for each of the plurality of blocks with respect to the reference frame image, or a direct current (DC) component of the plurality of blocks, the portion of the target frame as a target block, among the plurality of blocks, that has the determined difference that is greater than or equal to the predetermined threshold.

The generation of the compression feature may include a generation of the compression feature based on a result of applying the feature derivation model to the partial compression information and spatial information of the portion of the target frame, wherein the spatial information includes at least one of position information of the portion of the target frame or size information of the portion of the target frame.

The feature derivation model may be trained with a ground truth obtained by subtracting a feature of a first training frame image and a feature of a second training frame image from training partial compression information between the first training frame image and the second training frame image.

The execution of the code by the one or more processors may configure the one or more processors to select the reference frame image as a frame image, among the plurality of frame images, in which an object is detect, and determine, based on the selected reference frame image, a frame image among the plurality of frame images that is subsequent to the reference frame image to be the target frame images.

The execution of the code by the one or more processors may configure the one or more processors to perform a detection for an object in each of the plurality of frame images, and select, as the reference frame image, a frame image from among the plurality of frame images in which an object that was not detected in a previous frame image is detected as a result of the performed detection for the object or in which an object that was detected in the previous frame image is not detected as the result of the performed detection for the object.

The execution of the code by the one or more processors may configure the one or more processors to select another target frame image subsequent to the target frame image from among the plurality of frame images, and determine whether to reselect the reference frame image based on a portion of the other selected other target frame image having another determined difference with another corresponding portion of the reference frame image that is greater than or equal to the predetermined threshold.

Other features and aspects will be apparent from the following detailed description, the drawings, and the claims.

### BRIEF DESCRIPTION OF THE DRAWINGS

FIG. 1 illustrates an example method with feature generation according to one or more embodiments.

FIG. 2 illustrates example compression information according to one or more embodiments.

FIGS. 3A and 3B illustrate respective example partitioning of a target frame image into a plurality of blocks according to one or more embodiments.

FIG. 4 illustrates an example target feature generation operation according to one or more embodiments.

FIG. 5 illustrates an example compression feature derivation operation according to one or more embodiments.

FIG. 6 illustrates an example a task performance using a reference feature and/or a target feature according to one or more embodiments.

FIG. 7 illustrates an example electronic device according to one or more embodiments.

Throughout the drawings and the detailed description, unless otherwise described or provided, the same drawing reference numerals may be understood to refer the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

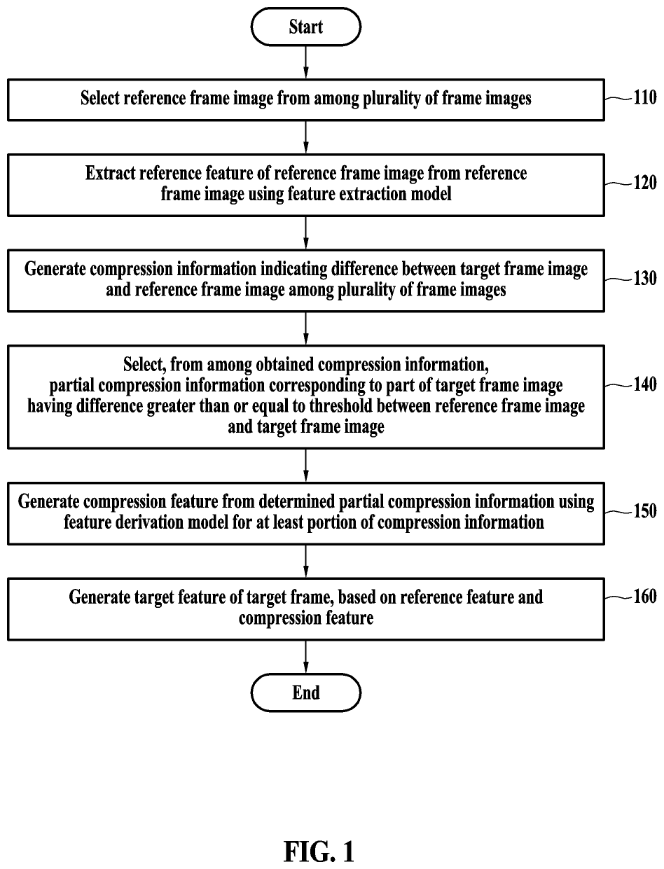

FIG. 1 illustrates an example method with feature generation according to one or more embodiments.

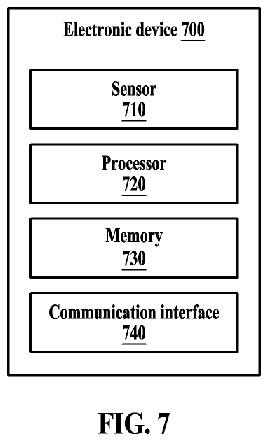

An electronic device may include a processor (i.e., one or more processors) and a memory (i.e., one or more memories) that may store instructions, which when executed by the processor configure the processor to perform one or more or all operations or methods described herein. As a non-limiting example, the processor and the memory may correspond to the processor 720 and memory 730 of FIG. 7.

For example, the processor may extract a feature from each of a plurality of frame images (e.g., of one or more videos). In an example, instead of extracting a respective feature from every frame image using a feature extraction model (i.e., a feature extraction model herein), the processor may extract a feature from a selected (reference) frame image, among the plurality of frame images, using the feature extraction model and generate respective features for other (target) frame images among the plurality of frame images using determined differences between the selected frame image and other frame images instead of (i.e., without) using the feature extraction model to extract the features of the other frame images. For example, if the feature extraction model were used to extract a feature from each of the plurality of frame images it may require significant computational resources and time, and/or may waste computational resources and time due to there being minimal differences between some image frames and some frames may not be appropriate for the underlying task. Rather, in one or more embodiments, by using a feature extraction model to extract respective features from only select (i.e., less than all) image frames among a plurality of image frames, and otherwise deriving the features of other image frames among the plurality of image frames without extracting the same directly using the feature extraction model, computational resource usage may be reduced and the respective features may be determined more quickly than if they had all been extracted with the feature extraction model.

In operation 110, the processor may select a reference frame image from among the plurality of frame images when a determined change occurs between temporarily adjacent frame images, which may be detected based on a determination of when differences between temporarily adjacent frame images meet a predetermined threshold. Selecting the reference frame image may include changing (e.g., updating) an already selected reference frame image (used in a previous implementation of the operations 110 through 160) to a newly selected reference frame image that is used in a current (below) implementation of the operations 110 through 160.

For example, the processor may select the reference frame image based on a determined difference between frame images. For example, the processor may select either a first frame image or a second frame image among the plurality of frame images (e.g., of a sequence of frame images, such as from a captured video) as the reference frame image based on the determined difference between the first frame image and the second frame image. The second frame image may be temporally adjacent to the first frame image among the plurality of frame images. The determined difference between the first frame image and the second frame image may be a value (e.g., a summation, an average, or maximum) based on determined differences between respective pixel values of corresponding pixels of the first and second frame images. While the determined difference may be a single value indicative of a determined extent of all differences between the first frame image and the second frame image, the determined difference may alternatively be a vector, as a non-limiting example, representing respective determined difference values that each represent a different determined extent of difference between the first frame image and the second frame image.

In an example, the processor may select, as the reference frame image, a temporally subsequent image among the first frame image and the second frame image when the determined difference between the first frame image and the second frame image is greater than or equal to a predetermined threshold difference. In an example where the determined difference is a vector, the predetermined threshold difference may a single predetermined threshold applicable to all values of the vector or a threshold vector of corresponding predetermined thresholds. The processor may increment through each pair of temporal frame images of the plurality of the frame images until two of the temporal frame images have a determined difference that meets the predetermined threshold difference. For example, with respect to a sequence of frame images, in an first operation a difference may be determined between an initial temporal frame image and an immediately subsequent temporal frame image (next image frame), and if that first operation difference is not equal to or greater than the predetermined threshold difference, a second operation is performed to determine the difference between the next image frame and the immediately subsequent temporal frame image of the next image frame, etc., until the determined difference between a determined pair of temporal image frames is equal to or greater than the predetermined threshold difference at which time the latest (subsequent) in time among that determined pair of temporal image frames is selected to be the reference frame image. Upon completion of operations 120 through 160 with respect to this selected reference frame image for each of one or more corresponding target frame images, operations 110 through 160 may be repeated for subsequent frame images.

For example, when extracting a feature for a security-dependent task, the processor may not extract a feature of a frame image for performing the security-dependent task until there is a predetermined sufficient low, minimum, or no change, in other words, until there is predetermined sufficient low, minimum, or no difference between the frame images, at which time a generated feature may be used for performing the security-dependent task. When a determined difference between first and second frame images is greater than or equal to the threshold, the processor may perform operations (e.g., operations 110 to 160) for extracting a feature of the selected reference frame image and/or deriving a feature of a target frame image by selecting the reference frame image.

In an example, the processor may detect for an object in at least one of the plurality of frame images (e.g., periodically, in a frame image of a predetermined number of frame images). For example, the processor may perform an object detection operation for each of the at least one of the plurality of frame images. The processor may designate the type of tracking target object. For example, the processor may detect for an object of human type, vehicle type, and/or animal type in differing embodiments. The object detection operation may be a well-known object detection algorithm. The processor may select the reference frame image based on whether an object is detected in the frame image or based on an object detected in the frame image.

For example, the processor may select, based an object being detected in a frame image among the plurality of frame images, as the reference frame image, the frame image in which the object is detected. Rather, in an example, the processor may not select any of the frame images that are not determined to include the object as the reference frame image.

For example, the processor may detect for an object in each of the plurality of frame images. The processor may select, as the reference frame image, a frame image in which an object is detected after a previous frame image in which the object is not detected. The previous frame image in which the object is not detected may be a frame image that temporally precedes and/or is adjacent to the frame image in which an object is detected.

In an example, the processor may select a new frame image in which an object is detected as the reference frame image when a new object that was not detected in the previous frame image is detected in the new frame image. In an example, the processor may select a next frame image as the reference frame image when an object that was detected in the previous frame image is not detected in the next frame image.

In operation 120, the processor may extract a reference feature of the reference frame image from the reference frame image using a feature extraction model. For example, the reference frame image may be input to the feature extraction model and a result of the feature extraction model may be reference feature. A reference feature may be a feature extracted of or from the reference frame image.

The feature extraction model may be a model configured and/or trained to generate, from input data corresponding to a frame image, data representing or corresponding to a feature of the frame image. The feature extraction model may include a machine learning model. For example, the feature extraction model may include a neural network, such as a convolution neural network (CNN) and/or a residual network (Reset).

The input to the feature extraction model may be in an input format corresponding to an image (e.g., pixel values of a plurality of pixels of the frame image). In an example, the input format may include multiple channels.

In operation 130, the processor may generate compression information indicating a difference between a target frame image, among the plurality of frame images, and the reference frame image.

For example, the processor may select, based on the reference frame image being selected, as the target frame image, at least one frame image among the plurality of frame images subsequent to the reference frame image. The processor may generate compression information indicating the difference between the target frame image and the reference frame image.

The processor may perform domain transfer of the reference frame image and the target frame image. For example, the processor may convert pixel values of each of the reference frame image and the target frame image from a red, green, and blue (RGB) domain to a YCbCr domain, as a non-limiting example. In an example, the reference frame image and the target frame image may have previously been converted to the YCbCr domain, e.g., upon respective captures by a sensor of the electronic device or upon storing to the memory of the electronic device subsequent to capture.

The processor may partition the target frame image into a plurality of blocks. The processor may generate, for each of the plurality of blocks, respective block compression information indicating the difference between a region corresponding to a corresponding block in the reference frame image and a corresponding block in the target frame image. Thus, compression information for the target image frame may include the respective block compression information for the plurality of blocks.

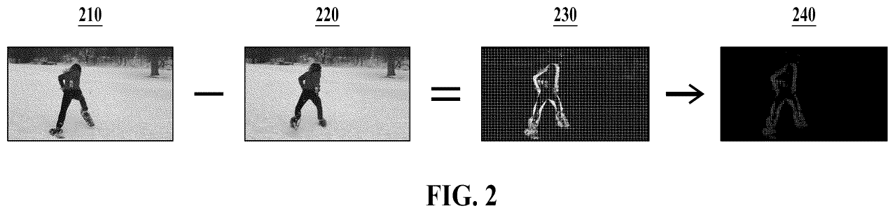

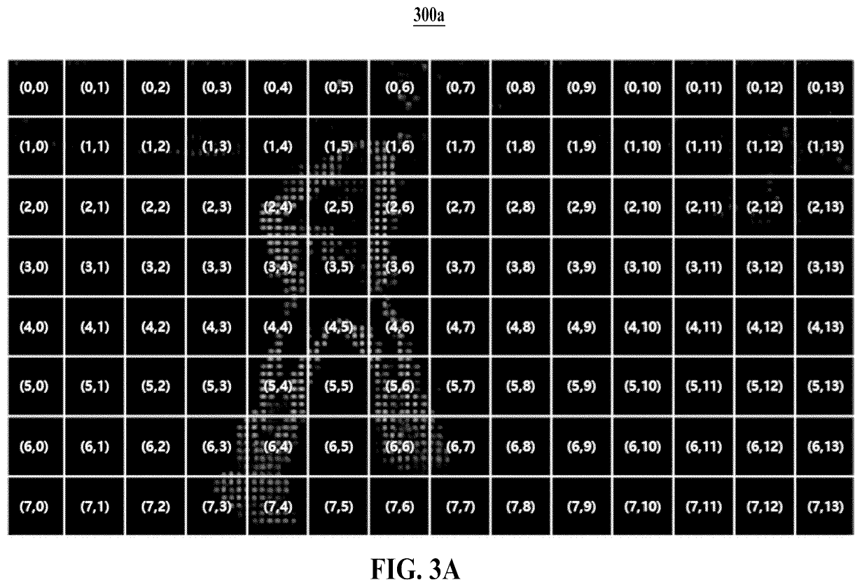

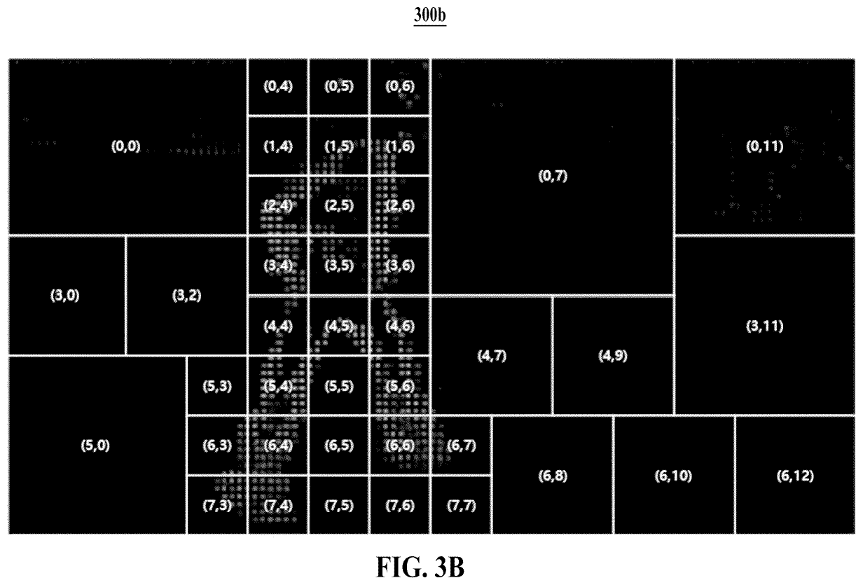

For example, the processor may generate (e.g., estimate) a motion vector of each block of the target frame image, generate a residual of each block of the target frame image, and/or perform frequency analysis (e.g., discrete cosine transform (DCT)) on a residual of each block of the target frame image (e.g., respectively according to well-known image compression algorithms). The processor may quantize each DCT result. A region corresponding to each block in the reference frame image may be determined based on a motion vector of a corresponding block of the target frame image. As an example, a motion vector (as the reference frame image and the target frame image are temporarily separated) may represent a relative positional relationship (e.g., direction and/or distance) between each block of the target frame image and a corresponding region (e.g., a region in which the same object appears) in the reference frame image. The processor may use the motion vector to generate the residual between a region corresponding to a corresponding block in the reference frame image and a corresponding block of the target frame image. The processor may generate a component for each frequency band of each block of the target frame image by applying the DCT to the residual of each block of the target frame image, the results of which may be the respective block compression information for each of the plurality of blocks of the target frame image. The processor may optionally quantize a component for each frequency band of each block of the target frame image generated through the DCT, and the quantized components may be the respective block compression information for each of the plurality of blocks of the target frame image. Compression information is described in more detail below with reference to FIGS. 2 and 3.

In operation 140, the processor may select, from among the generated compression information, partial compression information corresponding to those portion(s) of the target frame image that have a respective difference greater than or equal to a predetermined threshold between the reference frame image and the target frame image. The partial compression information may be compression information for portions of the target frame image that demonstrate or have significant differences with corresponding portions of the reference frame image.

For example, the processor may select, from among a plurality of blocks of the target frame image and based on at least one of the motion vector for each block of the target frame image, the residual of each block of the target frame image with respect to the reference frame image, or the DC and/or other components, one or more target blocks that have a respective difference greater than or equal to a predetermined threshold compared to the reference frame image. The respective block compression information of the selected one or more target blocks, distinguished from all respective block compression information of all of the plurality of blocks, may be referred to as the partial compression information.

For example, each respective block compression information of each block, of the plurality of blocks, may include a matrix having elements of which the number is the same as the number of pixels included in the corresponding block. Each element of the matrix may be a respective component (or a quantized component) value of a corresponding frequency band. The processor may determine a representative value (e.g., mean, median, maximum, or DC component) of all elements for each matrix of the respective block compression information of the plurality of blocks. The processor may select one or more target blocks from among the plurality of blocks, based on the determined representative values (e.g., for each representative value determined to be equal to or greater than the predetermine threshold the corresponding block may be selected to be a target block). In an example, the selecting of the target blocks may include selecting a predetermined number of blocks in order of the highest determined representative values of the respective block compression information.

In operation 150, the processor may generate a compression feature from the generated partial compression information using a feature derivation model. A compression feature may be a feature representing the difference between a reference feature and a target feature. The target feature may be a feature of the target frame image.

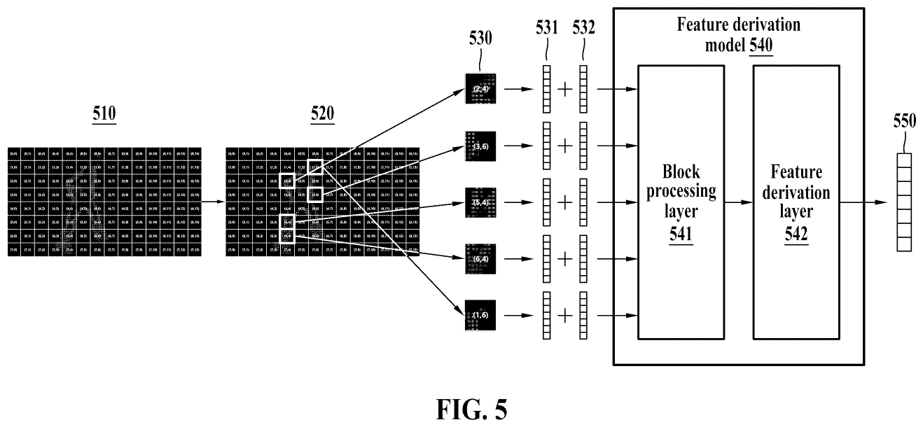

The feature derivation model may be a model configured and/or trained to generate, from input data corresponding to partial compression information, data representing or corresponding to the compression feature. The feature derivation model may include a machine learning model. For example, the feature derivation model may include a neural network, such as a CNN or a transformer, and/or other multi-layer perceptron. The feature derivation model may include a lesser number of parameters and/or require a lesser number of computational operations compared to the feature extraction model to generate an output for a corresponding input. An example operation of deriving such a compression feature based on such generated partial compression information is described in more detail below with reference to FIG. 5.

Thus, the processor may derive a difference (e.g., a compression feature) between the reference feature and the target feature using the feature derivation model provided the determined difference (e.g., compression information) between the target frame image and the reference frame image. In addition to the notations above, the processor may derive the target feature and/or the compression information with a lesser number of computations than a comparative example by using partial information (e.g., partial compression information) about a portion of the target frame image that has a difference greater than or equal to a threshold from the reference frame image instead of using all of the differences (e.g., compression information) between the reference frame image and the target frame image.

In operation 160, the processor may generate a target feature of the target frame image, based on the reference feature and the compression feature. For example, the processor may determine, as the target feature, a value generated by summing the reference feature and the compression feature.

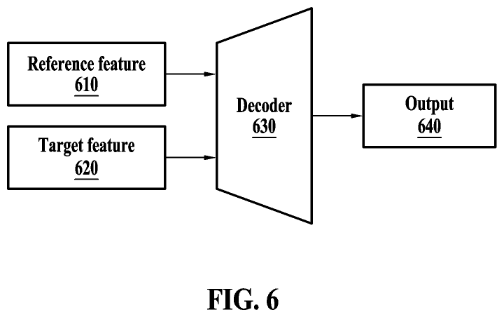

The processor may perform, based on the target feature, a task on the target frame image. A task may include, for example, object tracking and/or image captioning or labeling. A performing of a task using the reference feature and/or the target feature is described in more detail below with reference to FIG. 6.

The processor may derive features of multiple frame images subsequent to the reference frame image by repeatedly updating the target frame image (e.g., determining a respective next target frame image). For example, after determining a current target feature for a current target frame image, the processor may change (e.g., update) the target frame image to another frame image subsequent to the target frame image among the plurality of frame images.

The processor may also determine whether to reselect the reference frame image, based on a determination that a portion of the changed target frame image has a difference greater than or equal to a corresponding predetermined threshold from the reference frame image. When there are a large number of portions of the changed target frame image having respective differences greater than or equal to the corresponding predetermined threshold with the reference frame image, the processor may reselect the reference frame image (i.e., by setting the changed target frame image to be the reselected reference frame image instead of another target frame image) rather than using compression information between the reference frame image and the changed target frame image.

For example, the processor may determine whether to reselect the reference frame image, based on information (e.g., the number of target blocks and the size of a target block) about a block selected as a target block from among a plurality of blocks of the changed target frame image. The processor may reselect (e.g., change) the changed target frame image to be the (reselected) reference frame image when a threshold number or more of blocks of the changed target frame image are selected as target blocks or when the sizes (e.g., the number of pixels included in a block) of the blocks selected as target blocks are greater than or equal to a threshold size. Upon changing the changed target frame image to be the reselected reference frame image, the processor may select (e.g., change), as the next target frame image, at least one frame image temporally subsequent to the reselected reference frame image. The processor may perform operations (e.g., at least some of operations 110 to 160) for determining a next target feature of the next target frame, based on the changed reference frame image.

The processor may determine whether to generate a feature of another frame image, based on whether an object is detected in another image frame subsequent to the target frame image.

For example, after determining the target feature, the processor may detect for the object in another frame image subsequent to the target frame image among the plurality of frame images. The processor may change the reference frame image or the target frame image to be the other frame image, based on the object being detected in the other frame image as a result of the performed detecting for the object in the other frame image. When an object is detected in the other frame image, and when the object is the same as an object previously detected in the reference frame image, the processor may select the other frame image to be the target frame image and derive a feature of the other frame image. When an object is detected in the other frame image, and the detected object is different from the object previously detected in the reference frame image, the processor may select the other frame image to be the reference frame image, and perform operations 120 through 160. In an example, the processor may skip (or not perform) extracting (using the feature extraction model) and/or deriving (using the feature derivation model) of a feature of another frame image when a result of the performed detecting for the object does not result in the object being detected in the other frame image.

FIG. 2 illustrates example compression information according to one or more embodiments.

A processor of an electronic device (e.g., the electronic device 700 of FIG. 7) may determine a difference 230 between a reference frame image 210 and a target frame image 220. For example, the processor may determine, for each (or multiple) of a plurality of blocks of the target frame image 220, a respective difference between a region of the reference frame image 210 corresponding to a corresponding block of the target frame image 220.

The processor may generate compression information 240 by applying frequency transform (e.g., DCT) to each illustrated block of the difference 230. The processor may generate the compression information 240 by applying a frequency transform to each illustrated block of the difference 230 and then further applying quantization to each respective result of the frequency transforms.

FIGS. 3A and 3B illustrate respective example partitioning of a target frame image into a plurality of blocks according to one or more embodiments.

A processor of an electronic device (e.g., the electronic device 700 of FIG. 7) may partition a target frame image 300a into a plurality of blocks of the same size. For each block, the size of a corresponding block may be the total number of pixels included in the corresponding block or the total number of pixels (e.g., width) in a first axis direction and the total number of pixels (e.g., height) in a second axis direction included in the corresponding block. For example, the processor may partition, based on a moving picture experts group (MPEG) codec standard, the target frame image into the plurality of blocks of the same size (e.g., as respective macroblocks according to an MPEG standard). Referring to FIG. 3A, the target frame image 300a may be partitioned into 112 (e.g., 8×14) blocks having the same size, as a non-limiting example.

In an example, at least two blocks among the plurality of blocks partitioned from the target frame image may have different sizes. For example, the size of a first block among the plurality of blocks may be different from the size of a second block among the plurality of blocks. For example, the processor may partition the target frame image into a plurality of blocks of various sizes according to an AV1 codec standard. As an example, referring to FIG. 3B, a target frame image 300b may be partitioned into a plurality of blocks having various sizes. When the size of the first block is greater than the size of the second block, block compression information of the first block may have a difference less than or equal to block compression information of the second block. For example, a component of the block compression information of the first block may have a value less than or equal to a component of the block compression information of the second block. In other words, as the size of the respective blocks of the target frame image increase, a degree of change in the respective blocks of the target frame image may be less than corresponding regions in the reference frame image.

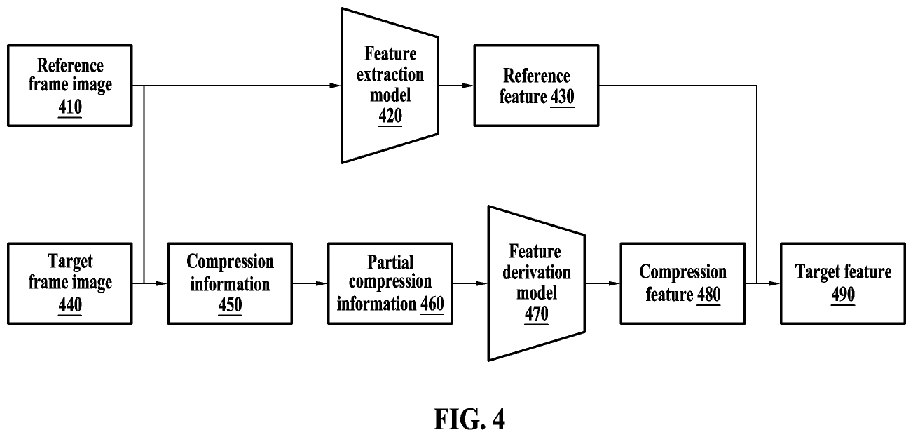

FIG. 4 illustrates an example of target feature generation operation according to one or more embodiments.

A processor of an electronic device (e.g., the electronic device 700 of FIG. 7) may generate a target feature 490 of a target frame image 440, based on a reference feature 430 of a reference frame image 410.

The processor may extract the reference feature 430 by applying a feature extraction model 420 to the reference frame image 410. For example, the referenced frame image 410 may be input to the feature extraction model 420, and a result of the feature extraction model 420 may be the extracted reference feature 430.

The processor may generate compression information 450 indicating the difference between the reference frame image 410 and the target frame image 440. The processor may determine (e.g., extract and select) partial compression information 460 regarding a part of the compression information in which the target frame image 440 has a difference greater than or equal to a threshold compared to the reference frame image 410.

The processor may generate a compression feature 480 based on the result of applying a feature derivation model 470 to the partial compression information 460. The compression feature 480 may represent the difference between the reference feature 430 and the target feature 490 due to the difference between the reference frame image 410 and the target frame image 440. Here, it is noted that at the time the compression feature 480 is derived the target feature 490 has not yet been generated. Rather, the processor may then generate the target feature 490 (e.g., a feature of the target frame image 440), such as by summing the reference feature 430 and the compression feature 480.

The feature derivation model 470 may include a model configured and/or trained to output, from the input of such partial compression information, a compression feature. As a non-limiting example, the training of the feature derivation model 470 may include training the feature derivation model 470 to output, from training input partial compression information (e.g., for a training target image), an output training compression feature having a value equal to or similar (e.g., trained toward a trained minimalized loss or error) to a value generated by subtracting a training reference feature (e.g., corresponding to a training reference image and the training input partial compression information) from a ground truth for the training compression feature for the training target image. The ground truth feature of the training target frame image may be a feature extracted from the training target frame image using the feature extraction model 420, as a non-limiting example.

For example, the ground truth feature, the training reference feature, and the output training compression feature of the training target frame image may satisfy Equation 1 below.

$$C ( {\hat{x}}_{k} \vert F ) = {f}_{k} = {F}_{k} - F \qquad Equation 1$$

Here, F may denote the training reference feature (e.g., having a correspondence with to the reference feature 430) of the training reference frame image (e.g., having a correspondence with to the reference frame image 410), \hat{x}ₖ may denote the training partial compression information (e.g., having a correspondence with to the partial compression information 460) between the training reference frame image and the training target frame image (e.g., having a correspondence with to the target frame image 440), C may denote the in-training feature derivation model 470, fₖ may denote the output training compression feature (e.g., having a correspondence with to the compression feature 480) of the training target frame image, and Fₖ may denote the ground truth feature of the training target frame image. Accordingly, FIG. 4 may represent the training operations of feature derivation model 470, in addition to the aforementioned inference (e.g., non-training) operation descriptions of FIG. 4.

Thus, as noted, feature derivation model 470 may be a model trained using, as the ground truth, a value generated by subtracting a feature of a first training frame image and a feature of a second training frame image from the training partial compression information (e.g., having a correspondence with to the partial compression information 460) between the first training frame image (e.g., the training reference frame image) and the second training frame image (e.g., the training target frame image). The training partial compression information may be compression information for a portion of the second training frame image that has a difference, compared to the first training frame image, that is greater than or equal to a predetermined threshold. A feature of the first training frame image may be a feature extracted from the first training frame image by using the feature extraction model 420. Similarly, a feature of the second training frame image may be a feature extracted from the second training frame image by using the in-training feature extraction model 420. Here, the feature derivation model 470 may be trained by the processor or a processor of one or more other electronic devices (e.g., a training device) other than the electronic device. Each of the other electronic devices may have any configuration of the electronic device 700, as a non-limiting example.

The feature derivation model may be trained subsequent to the feature extraction model (e.g., without affecting a value of a parameter of the feature extraction model). For example, the feature derivation model may be trained after the training (according to an embodiment) of the feature extraction model is completed, and performed without changing the value of the parameter of the feature extraction model.

FIG. 5 illustrates an example compression feature derivation operation according to one or more embodiments.

A processor of an electronic device (e.g., the electronic device 700 of FIG. 7) may generate compression information for a plurality of blocks of a target frame image 510.

The processor may select each of target blocks 530 from among the plurality of blocks of a target frame image 520. As described above with respect to operation 140 of FIG. 1, the target block 530 may be a block among the plurality of blocks that has a difference greater than or equal to a threshold compared to the reference frame image.

The processor may generate partial compression information (as respective vectors 531) for each of the selected target blocks 530. When components for each frequency band included in the block compression information is included in the partial compression information, each of the partial compression information may include a component (e.g., a DC component) of a predetermined frequency band and/or one or more representative values (e.g., at least one of an average, a maximum value, or a median) of the components (e.g., of remaining frequency components other than or along with the DC component). Partial compression information for a corresponding block may also be expressed as a feature value and/or a feature vector of the corresponding block.

In an example, the processor may extract the compression feature 550 based on a result of applying the feature derivation model 540 to respective position information of each the target block 530 or size information of each the target block 530 in addition to the corresponding partial compression information of each target block 530. For example, the processor may generate the compression feature 550 by further utilizing information (e.g., a corresponding additional vector 532) indicating the position or size of the target block 530 together with corresponding partial block compression information 531 for each target block 530, respectively input to the feature derivation model 540.

For example, after selecting each of the target blocks 530, the processor may generate the additional vector 532 (e.g., a position vector and a size vector) for each target block 530. For example, the position information of a predetermined block within the target frame image may be converted into a position vector through positional encoding. The processor may apply a feature value (e.g., as respective vectors 531) of each of the target blocks 530 and a position vector (e.g., as respective additional vectors 532) of the target block 530 to the feature derivation model 540.

The feature derivation model 540 may include a block processing layer 541 and a feature derivation layer 542. The block processing layer 541 may include one or more layers configured to process the block compression information 531 of the target block 530 and the additional vector 532 of the target block 530. For example, the block processing layer 541 may include/perform a transformer-based self-attention mechanism/operation. The feature derivation layer 542 may include one or more layers configured to derive the compression feature 550 of target block(s) 530 based on an output of the block processing layer 541. For example, the feature derivation layer 542 may include a multi-layer perceptron.

FIG. 6 illustrates an example a task performance using a reference feature and/or a target feature according to one or more embodiments.

A processor of an electronic device (e.g., the electronic device 700 of FIG. 7) may perform a task based on a reference frame image and/or a target frame image by respectively using a reference feature 610 and/or a target feature 620. The task may include, for example, object detection, object recognition, object tracking, and/or image captioning or labeling, as non-limiting examples. The reference feature 610 and the target feature 620 may be generated as described above with respect to any of FIGS. 1-5.

For example, based on the reference feature 610 and the target feature 620, the processor may track an object appearing in the reference frame image and subsequently in the target frame image or output a caption (or label) text describing a scene appearing in the reference frame image and the target frame image.

For example, the processor may apply the reference feature 610 or the target feature 620 to a decoder 630. The decoder 630 may be a model configured and/or trained to output an output 640 for a predetermined task based on an input feature of an image. The decoder 630 may be implemented, for example, using at least a portion of a machine learning model, such as a neural network, a transformer, or a large language model (LLM).

The decoder 630 may have various output forms corresponding to different tasks according to different embodiments. For example, when the task is object detection, object tracking, or object recognition, the decoder 630 may output information (e.g., the size of a bounding box and the position of a bounding box) about a bounding box indicating a region in which an object appears in the reference frame image or the target frame image or information about the identity or type of an object appearing in the bounding box. For example, when the task is image captioning (or video captioning), the decoder 630 may output text data describing a scene appearing in the reference frame image or the target frame image.

In an example, the decoder 630 may be trained independently of the feature extraction model(s) and/or the feature derivation model(s) respectively described above with respect to FIGS. 1-5. However, examples are not limited thereto, and the decoder 630 may be trained (e.g., through end-to-end training) together with any of the feature derivation model(s) described above with respect to FIGS. 1-5, or together both of any of the feature extraction models and any of the feature derivation models described above with respect to FIGS. 1-5.

FIG. 7 illustrates an example electronic device according to one or more embodiments.

An electronic device 700 may include a sensor 710, a processor 720, a memory 730, and a communication interface 740. The sensor 710, the processor 720, the memory 730, and the communication interface 740 may respectively represent one or more sensors 710, one or more processors 720, one or more memories 730, and one or more communication interfaces 740.

The sensor 710 may obtain or capture a plurality of frame images. For example, the sensor 710 may be an image or video sensor or camera. As a non-limiting example, the sensor 710 may capture or generate an image with multiple channels, such as respective RGB channels.

The processor 720 may be configured to execute instructions (e.g., instructions stored in the memory 730), which when executed by the processor 720 may configure the processor 720 to perform one or more or all operations or methods described above with respect to FIGS. 1-6. For example, the processor 720 may select a reference frame image, extract a reference feature by using a feature extraction model (e.g., a first machine learning model), generate compression information indicating a difference between a target frame image and the reference frame image, determine partial compression information from the compression information, generate a compression feature from the partial compression information using a feature derivation model (e.g., a second machine learning model), and generate a target feature of a target frame image based on the reference feature and the compression feature.

The memory 730 is a non-transitory computer-readable storage medium, such as described further below, that is/are configured to temporarily and/or permanently store at least one of each of a plurality of frame images, the reference frame image, the feature extraction model, the reference feature, the target frame image, the compression information, the partial compression information, the feature derivation model, the compression feature, or the target feature. As noted above, the memory 730 may store the instructions that when executed by the processor 720 configures or causes the processor 720 to perform the selecting of the reference frame image, the extracting of the reference feature, the generating of the compression information, the determining the partial compression information, the generating of the compression feature, and/or the generating of the target feature. However, these are only examples, and information stored in the memory 730 is not limited thereto.

The communication interface 740 is a circuit or circuitry-based hardware that is configured to transmit and receive at least one of each of the plurality of frame images, the reference frame image, the feature extraction model, the reference feature, the target frame image, the compression information, the partial compression information, the feature derivation model, the compression feature, or the target feature. The communication interface 740 may represent one or more transceivers or other known communication modules/busses that is/are configured to establish wired communication channel(s) and/or a wireless communication channel(s) between the sensor 710, the processor 720, and the memory 730 (e.g., as one or more communication busses), and/or with one or more external devices (e.g., one or more processing devices, one or more other electronic device(s) 700, and/or one or more servers) and, as non-limiting examples, may establish communication with the external device(s) via a long-range communication network, such as cellular communication, short-range wireless communication, local area network (LAN) communication, Bluetooth™, wireless-fidelity (Wi-Fi) direct or infrared data association (IrDA), a legacy cellular network, a fourth generation (4G) and/or 5G network, next-generation communication, the Internet, or a computer network (e.g., a LAN or a wide area network (WAN)), to perform such transmissions and receptions.

The sensors, cameras, processors, memories, communication interfaces, and electronic devices described herein, including descriptions with respect to respect to FIGS. 1-7, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (i.e., code) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-7 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
extracting a reference feature of a reference frame image, among a plurality of frame images, using a feature extraction model;
generating partial compression information corresponding to a portion of a target frame image, where the portion of the target frame has a determined difference with a corresponding portion of the reference frame image that is greater than or equal to a predetermined threshold;
generating a compression feature from the generated partial compression information using a feature derivation model; and
generating, based on the reference feature and the compression feature, a target feature of the target frame image.

2. The method of claim 1,
wherein the generating of the partial compression information comprises generating respective compression information, including the partial compression information, representing differences between the target frame image and the reference frame image, including:
partitioning the target frame image into a plurality of blocks; and
determining, for each of the plurality of blocks, respective block compression information indicating a corresponding difference between a region corresponding to a corresponding block among the plurality of blocks and a corresponding block of the target frame image, and
wherein the partial compression information is selected from among the respective compression information based on the determined difference.

3. The method of claim 2, wherein a size of a first block among the plurality of blocks is different from a size of a second block among the plurality of blocks.

4. The method of claim 1,
wherein the generating of the partial compression information comprises generating respective compression information, including the partial compression information, representing differences between the target frame image and the reference frame image, and
wherein the method further comprises:
partitioning the target frame image into a plurality of blocks; and
selecting the portion of the target frame image by selecting, based on at least one of a motion vector of each of the plurality of blocks, a residual for each of the plurality of blocks with respect to the reference frame image, or a direct current (DC) component of the plurality of blocks, the portion of the target frame as a target block, among the plurality of blocks, that has the determined difference that is greater than or equal to the predetermined threshold.

5. The method of claim 1, wherein the generating of the compression feature comprises generating the compression feature based on a result of applying the feature derivation model to the partial compression information and spatial information of the portion of the target frame, wherein the spatial information includes at least one of position information of the portion of the target frame or size information of the portion of the target frame.

6. The method of claim 1, wherein the feature derivation model is trained with a ground truth obtained by subtracting a feature of a first training frame image and a feature of a second training frame image from training partial compression information between the first training frame image and the second training frame image.

7. The method of claim 1, further comprising selecting, as the reference frame image, one of a first frame image or a second frame image, respectively among the plurality of frame images, based on a determined difference between the first frame image and the second frame image.

8. The method of claim 1, further comprising:
selecting the reference frame image as a frame image, among the plurality of frame images, in which an object is detected; and
determining, based on the selected reference frame image, a frame image among the plurality of frame images that is subsequent to the reference frame image to be the target frame image.

9. The method of claim 1, further comprising:
performing a detecting for an object in each of the plurality of frame images; and
selecting, as the reference frame image, a frame image from among the plurality of frame images in which an object that was not detected in a previous frame image is detected as a result of the performed detecting or in which an object that was detected in the previous frame image is not detected as the result of the performed detecting.

10. The method of claim 1, further comprising:
selecting another target frame image subsequent to the target frame image from among the plurality of frame images; and
determining whether to reselect the reference frame image based on a portion of the other selected other target frame image having another determined difference with another corresponding portion of the reference frame image that is greater than or equal to the predetermined threshold.

11. The method of claim 1, further comprising:
performing a detecting for an object in each of other frame images, subsequent to the target frame image, from among the plurality of frame images;
selecting, based on the object being detected in one frame image of the other frame images as a result of the performed detecting, the one frame image to be another reference frame image or another target frame image; and
generating features for the other frame images, except for any of the other frame images for which the performed detecting resulted in the object not being detected, using the feature extraction model or the feature derivation model.

12. The method of claim 1, further comprising:
tracking, based on the reference feature and the target feature, an object appearing in the reference frame image and the target frame image; or
generating, based on the reference feature and the target feature, caption text describing a scene appearing in the reference frame image and the target frame image.

13. A non-transitory computer-readable storage medium storing instructions that, when executed by a processor, cause the processor to perform the method of claim 1.

14. An electronic device comprising:
one or more processors respectively comprising processing circuitry; and
a memory storing code, which upon execution by the one or more processors, configures the one or more processors to:
extract a reference feature of a reference frame image, among a plurality of frame images, using a feature extraction model;
generate partial compression information corresponding to a portion of a target frame image, where the portion of the target frame has a determined difference with a corresponding portion of the reference frame image that is greater than or equal to a predetermined threshold;
generate a compression feature from the generated partial compression information using a feature derivation model; and
generate, based on the reference feature and the compression feature, a target feature of the target frame image.

15. The electronic device of claim 14,
wherein the generation of the partial compression information comprises a generation of respective compression information, including the partial compression information, representing differences between the target frame image and the reference frame image, and
wherein the execution of the code by the one or more processors configures the one or more processors to:
partition the target frame image into a plurality of blocks; and
select the portion of the target frame image by selecting, based on at least one of a motion vector of each of the plurality of blocks, a residual for each of the plurality of blocks with respect to the reference frame image, or a direct current (DC) component of the plurality of blocks, the portion of the target frame as a target block, among the plurality of blocks, that has the determined difference that is greater than or equal to the predetermined threshold.

16. The electronic device of claim 14, wherein the generation of the compression feature comprises a generation of the compression feature based on a result of applying the feature derivation model to the partial compression information and spatial information of the portion of the target frame, wherein the spatial information includes at least one of position information of the portion of the target frame or size information of the portion of the target frame.

17. The electronic device of claim 14, wherein the feature derivation model is trained with a ground truth obtained by subtracting a feature of a first training frame image and a feature of a second training frame image from training partial compression information between the first training frame image and the second training frame image.

18. The electronic device of claim 14, wherein the execution of the code by the one or more processors configures the one or more processors to:
select the reference frame image as a frame image, among the plurality of frame images, in which an object is detect; and
determine, based on the selected reference frame image, a frame image among the plurality of frame images that is subsequent to the reference frame image to be the target frame images.

19. The electronic device of claim 14, wherein the execution of the code by the one or more processors configures the one or more processors to:
perform a detection for an object in each of the plurality of frame images; and
select, as the reference frame image, a frame image from among the plurality of frame images in which an object that was not detected in a previous frame image is detected as a result of the performed detection for the object or in which an object that was detected in the previous frame image is not detected as the result of the performed detection for the object.

20. The electronic device of claim 14, wherein the execution of the code by the one or more processors configures the one or more processors to:
select another target frame image subsequent to the target frame image from among the plurality of frame images; and
determine whether to reselect the reference frame image based on a portion of the other selected other target frame image having another determined difference with another corresponding portion of the reference frame image that is greater than or equal to the predetermined threshold.
